(19) United States
(12) Patent Application Publication
(10) Pub. No.: US 2016/0052147 A1
(43) Pub. Date: Feb. 25, 2016

(54) CONFORMABLE MAGNETIC HOLDING DEVICE

(71) Applicant: GM GLOBAL TECHNOLOGY OPERATIONS LLC, Detroit, MI (US)

(72) Inventors: John Patrick Spicer, Plymouth, MI (US); Jianying Shi, Oakland Township, MI (US)

(73) Assignee: GM GLOBAL TECHNOLOGY OPERATIONS LLC, Detroit, MI (US)

(21) Appl. No.: 14/746,083

(22) Filed: Jun. 22, 2015

Related U.S. Application Data
(60) Provisional application No. 62/038,992, filed on Aug. 19, 2014.

(51) Int. Cl. B25J 15/06; B23Q 3/154

(52) U.S. Cl. CPC B25J 15/0608; B23Q 3/1543; B23Q 3/1546

(57) ABSTRACT

A device for holding a workpiece includes a holder including a base including a magnetic element. A conformable jamming element attaches to the base and includes a closed impermeable pliable membrane containing magnetic particles. A controllable pressure device fluidly couples to the jamming element.

### CROSS-REFERENCE TO RELATED APPLICATIONS

This application claims the benefit of U.S. Provisional Application No. 62/038,992, filed Aug. 19, 2014, which is hereby incorporated by reference in its entirety.

### TECHNICAL FIELD

This disclosure relates to workpiece-gripping devices for fixtures, tooling, material handling and robotic end-effectors.

### BACKGROUND

Universal grippers for tooling, fixtures and robotic end-effectors advantageously employ holding devices that attach to a variety of arbitrarily-shaped workpieces for movement and placement during manufacturing and assembly processes. Universal grippers may employ some form of external power to effect gripping and release, including vacuum-based suction grippers and anthropomorphic, multi-digit grippers for grasping and manipulating workpieces.

Passive universal grippers require minimal grasp planning They include components that passively conform to unique workpiece geometries, giving them the ability to grip widely varying workpieces without readjustment. Passive universal grippers are generally simpler to use and require minimal visual preprocessing of their environment. However, an ability to grip many different workpieces often renders passive universal grippers inferior at gripping any one workpiece in particular.

One passive, universal jamming gripper employs granular materials contained in a pliable membrane that conforms to a surface of a workpiece by applying a jamming force. Such operation exploits temperature-independent fluid-like characteristics of the granular materials, which can transition to a solid-like pseudo-phase with application of a vacuum inside the pliable membrane. This type of gripper employs static friction from surface contact, capture of the workpiece by conformal interlocking, and vacuum suction when an airtight seal is achieved on some portion of the workpiece surface. A jamming gripper employs static friction from surface contact, capture of workpiece by interlocking, and vacuum suction to grip different workpieces of varying shape, weight and fragility in an open loop configuration without employing grasp planning, vision, or sensory feedback.

### SUMMARY

A device for holding a workpiece includes a holder including a base including a magnetic element. A conformable jamming element attaches to the base and includes a closed impermeable pliable membrane containing magnetic particles. A controllable pressure device fluidly couples to the jamming element.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

One or more embodiments will now be described, by way of example, with reference to the accompanying drawings, in which:

FIG. 1 schematically illustrates a two-dimensional side view of a conformable holding device including a conformable jamming element containing ferromagnetic materials and a base including magnetic elements, in accordance with the disclosure;

FIG. 2 schematically illustrates a two-dimensional side view of a second embodiment of a conformable holding device including a conformable jamming element containing magnetic fluids and a base including controllable electro-magnetic elements, in accordance with the disclosure;

FIG. 3 schematically shows a three-dimensional partially translucent isometric: view of a workpiece holder including a plurality of conformable holding devices each having a controllable electro-magnetic element configured to conformally interface with a workpiece at corresponding gripping locations, wherein the workpiece is secured on top of the holder, in accordance with the disclosure; and

FIG. 4 schematically shows a three-dimensional partially translucent isometric view of a workpiece holder including a plurality of conformable holding devices each having a controllable electro-magnetic element configured to conformally interface with a workpiece at corresponding gripping locations, wherein the workpiece is secured below the holder, in accordance with the disclosure.

### DETAILED DESCRIPTION

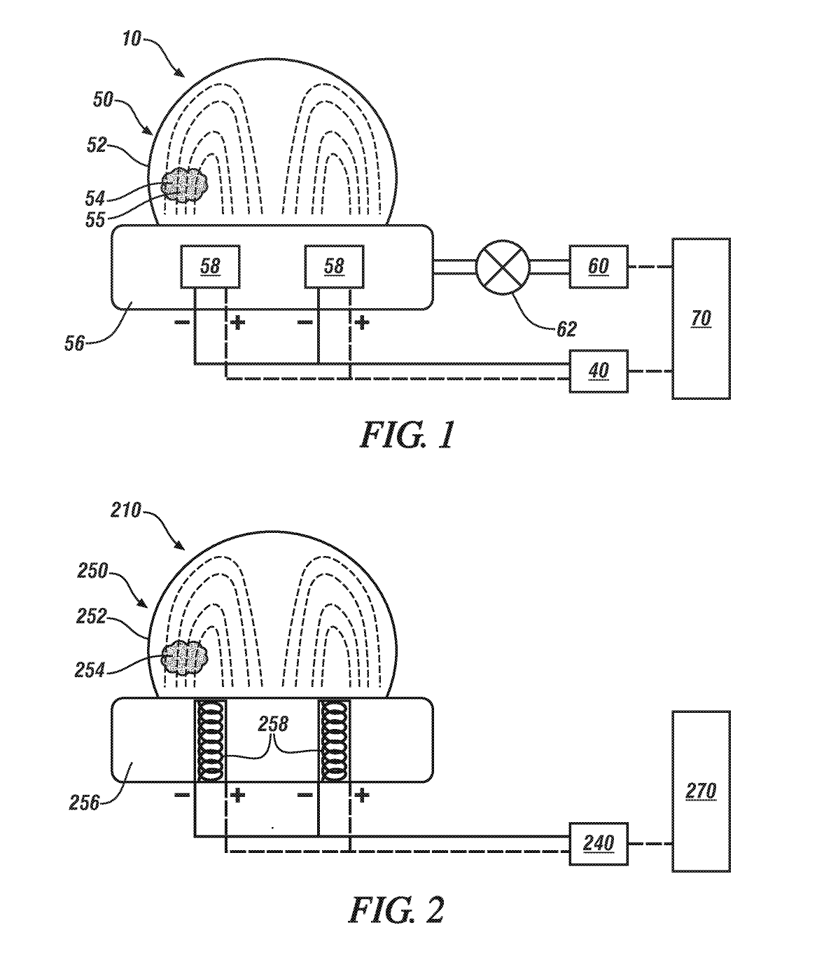

Referring now to the drawings, wherein the depictions are for the purpose of illustrating certain exemplary embodiments only and not for the purpose of limiting the same, FIG. 1 schematically illustrates a two-dimensional side view of a conformable holding device 10 including a conformable jamming element 50 containing granular filling material 54 and ferromagnetic particles 55 and a base 56 including magnetic elements 58 in one embodiment. In one embodiment, the magnetic elements 58 are permanent magnets. Alternatively, the magnetic elements 58 are controllable electro-magnetic elements 58 that are controlled by an electro-magnet activation controller 40, as shown. The holding device 10 may be employed on an end effector of a robotic arm to controllably grip or otherwise hold onto a workpiece or assist in holding onto a workpiece to restrain the workpiece at a location or carry the workpiece to another location.

The jamming element 50 includes an air-impermeable pliable membrane 52 that sealably attaches to the base 56 and contains the granular filling material 54 and the ferromagnetic particles 55. The base 56 attaches to an end-effector of a robotic arm in one embodiment. Suitable materials from which the membrane 52 may be fabricated include latex, vinyl, coated fabric, and metal foil among others. The membrane material is air-impermeable and is preferably resistant to tearing, e.g., by using multiple layers. Suitable material for the granular filling material 54 includes cracked corn, ground coffee and pulverized plastics among others. Preferably the granular filling material 54 is magnetically inert. The ferromagnetic particles 55 include dry materials having a large, positive susceptibility to an external magnetic field and exhibiting a strong attraction to magnetic fields. Iron, nickel, and cobalt are examples of ferromagnetic materials. The base 56 includes a fluid conduit that fluidly couples to a controllable pressure source 60 via a valve 62. The pressure source 60 generates negative pressure (vacuum) within the jamming element 50 in response to a first control signal to effect gripping, and permits vacuum release or generates positive pressure within the jamming element 50 in response to a second control signal to effect release. The base 56 also includes one or an arrangement of controllable electro-magnetic elements 58 that interact with the ferromagnetic particles 55.

The controllable electro-magnetic elements 58 electrically connect to an electro-magnet activation controller 40 that controls activation thereof. A system controller 70 signally connects to the activation controller 40 and the pressure source 60 to effect attachment to and detachment from the workpiece. When the magnetic elements 58 are permanent magnet elements, detachment from the workpiece may include use of a twisting action of the magnetic elements 58 or the workpiece.

The jamming element 50 operates by contacting and conforming to the shape of the workpiece when urged against the workpiece. A vacuum is applied to vacuum-harden the filled membrane 52 to rigidly grip the workpiece. Simultaneously or immediately subsequently, the electro-magnet activation controller 40 activates the controllable electro-magnetic elements 58, which magnetically attract and bind the workpiece to a portion of the filled membrane 52 that is contiguous to the workpiece. After work has been performed on the workpiece or it has been transported to another location, one or more bursts of positive pressure are applied to reverse the fluid-like-to-solid-like phase transition, i.e., reverse the jamming. The electro-magnet activation controller 40 deactivates the controllable electro-magnetic elements 58 to forcibly release the workpiece and return the filled membrane 52 to a deformable, ready state.

The terms controller, control module, module, control, control unit, processor and similar terms refer to any one or various combinations of Application Specific Integrated Circuit(s) (ASIC), electronic circuit(s), central processing unit(s), e.g., microprocessor(s) and associated memory and storage devices (read only, programmable read only, random access, hard drive, etc.) executing one or more software or firmware programs or routines, combinational logic circuit(s), input/output circuit(s) and devices, signal conditioning and buffer circuitry and other components to provide a described functionality. Software, firmware, programs, instructions, control routines, code, algorithms and similar terms mean any controller-executable instruction sets including calibrations and look-up tables. Each controller executes control routine(s) to provide desired functions, including monitoring inputs from sensing devices and other networked controllers and executing control and diagnostic routines to control operation of actuators. Routines may be executed at regular intervals. Alternatively, routines may be executed in response to occurrence of an event, such as an external command. Communications between controllers and between controllers, actuators and/or sensors may be accomplished using a direct wired link, a networked communications bus link, a wireless link or any another suitable communications link.

FIG. 2 schematically illustrates a two-dimensional side view of a conformable holding device 210 including a conformable jamming element 250 containing magnetic fluids 254 and a base 256 including controllable electro-magnetic elements 258. The conformable jamming element 250 may be employed on an end effector of a robotic arm to controllably grip or otherwise hold onto a workpiece or assist in holding onto a workpiece. The conformable jamming element 250 includes an air-impermeable pliable membrane 252 that sealably attaches to the base 256 and contains magnetic fluids 254. The base 256 attaches to an end-effector of a robotic arm in one embodiment. Suitable materials from which the membrane 252 may be fabricated include latex, vinyl, coated fabric and metal foil among others. The membrane material is air-impermeable and is preferably resistant to tearing, e.g., by using multiple layers. Suitable material for the magnetic fluids 254 includes ferro-fluids and magnetorheological fluids. Ferro-fluids are colloidal liquids that include nanoscale ferromagnetic particles that are suspended by Brownian motion in a carrier fluid, typically an organic solvent or water, and become magnetized in the presence of a magnetic field. Magnetorheological fluids include micrometer-scale particles that are suspended in a carrier fluid, typically a hydrocarbon-based oil. The magnetorheological fluids increase apparent viscosity in the presence of a magnetic field and become viscoelastic solids with a high, controllable yield stress. The base 256 includes one or an arrangement of controllable electro-magnetic elements 258 that interact with the magnetic fluids 254. The controllable electro-magnetic elements 258 may project into the conformable jamming element 250 in one embodiment. The controllable electro-magnetic elements 258 electrically connect to an electro-magnet activation controller 240 that controls activation thereof. A system controller 270 signally connects to the activation controller 240 to effect attachment and detachment to the workpiece.

The jamming element 250 operates by contacting a workpiece and conforming to the shape of the workpiece. The electro-magnet activation controller 240 activates the controllable electro-magnetic elements 258, which grips the workpiece and may also magnetically attract and bind the workpiece to a portion of the membrane 252 contiguous to the workpiece. Subsequently, deactivating the electro-magnet activation controller 240 deactivates the controllable electro-magnetic elements 258 to forcibly release the workpiece and return (reset) the filled membrane 252 to a deformable, ready state.

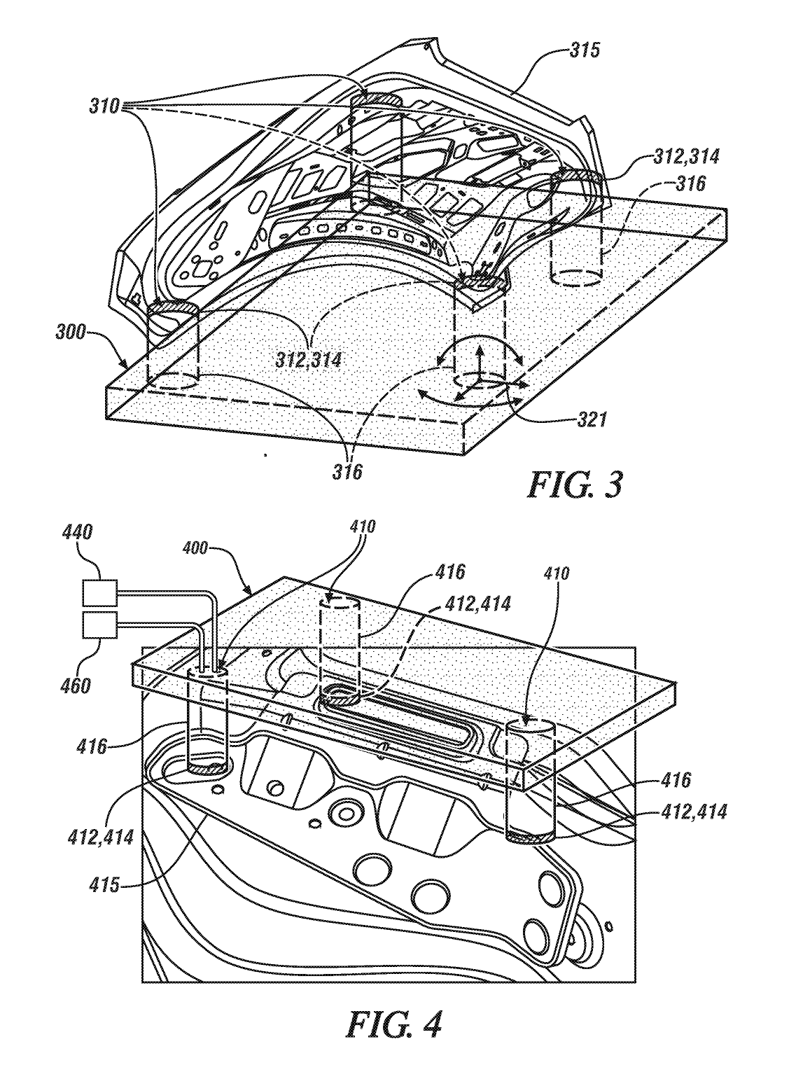

FIG. 3 schematically shows a three-dimensional isometric view of a workpiece holder 300 that may be in the form of a fixture, tooling or a robotic end-effector that has been configured to conformally interface with a workpiece 315 at a plurality of gripping locations. The holder 300 includes a plurality of conformable holding devices 310 analogous to the holding device 10 described with reference to FIG. 1 or the holding device 210 described with reference to FIG. 2. In one embodiment, the holder 300 includes a single one of the holding devices 310. Each of the conformable holding devices 310 includes a conformable jamming element 312 containing ferromagnetic materials 314 and a base 316 including controllable electro-magnetic elements 318. As shown, the workpiece 315 rests on top of the holder 300 and the workpiece 315 is secured thereto by electromagnetic holding force applied to the conformed surface of the holding devices 310. Activation of the holding devices 310 is controlled by a controllable pressure source and an electro-magnet activation controller. The holding devices 310 are depicted as orthogonal to a planar surface of the holder 300, but it is appreciated that the holding devices 310 may be arranged in any suitable orientation with reference to the holder 300. Alternatively, the conformable holding devices 310 include a conformable jamming element 312 containing magnetic fluids. Furthermore, as indicated by element 321, individual ones of the holding devices 310 may be moveable to different positions on the holder 300, including being configured for xy-plane translation on the surface of the holder 310, extension in a z-direction, or rotation about an x-axis, a y-axis, and/or a z-axis, i.e., pitch, yaw and/or roll rotations, thus having as many as six degrees of freedom of motion to accommodate and adapt to workpieces 315 having different geometries. The chosen degrees of freedom may be any combination of x,y,z translations and/or pitch/yaw/roll rotations.

FIG. 4 schematically shows a three-dimensional isometric view of a workpiece holding device 400 that may be in the form of a fixture, tooling or a robotic end-effector that has been configured to conformably interface with a workpiece 415 at a plurality of gripping locations. The holder 400 includes a plurality of conformable holding devices 410 analogous to the holding device 10 described with reference to FIG. 1 or the holding device 210 described with reference to FIG. 2. As such, each of the conformable holding devices 410 includes a jamming element 412 containing ferromagnetic materials 414 and a base 416 including controllable electro-magnetic elements 418. As shown, the workpiece 415 suspends from and adheres to the holder 400 with the workpiece 415 secured thereto by magnetic holding force applied to the conformed surface of the holding devices 410. Alternatively, the conformable holding devices 410 include a conformable jamming element 412 containing magnetic fluids.

In operation, an embodiment of the holder 400 including one or a plurality of conformable holding devices 410 including conformable jamming elements 412 and ferromagnetic materials 414 operates as follows. Initially each holding device 410 is static, i.e., no vacuum is applied. An end-effector urges the holding device 410 against a portion of the workpiece 415 by a force of a magnitude that is sufficient to conform the holding device 410 to the surface of the workpiece 415. A pressure source 460 is activated to generate negative pressure (vacuum) within the jamming element 412 to jam the particles to maintain the conformed shape and provide some holding force for external features. Simultaneously, or immediately subsequently, an electro-magnet activation controller 440 activates the controllable electro-magnetic elements 418, causing the ferromagnetic materials 414 to generate a holding force. The pressure source 460 and the electro-magnet activation controller 440 are schematically shown as being connected to a single one of the holding devices 410; however, it is appreciated that they connect to all of the holding devices 410 of the holder 400. The holder 400 is moved by a robotic arm to a desired location to do work on the workpiece 415. After the work is completed, the pressure source 460 is deactivated to release the vacuum, allowing the conformed shape of the jamming element 412 to relax. Simultaneously, the electro-magnet activation controller 240 deactivates the controllable electro-magnetic elements 418. Such actions release the workpiece 415 from the holding device 410. The configuration enables use of any suitable workpiece grip orientation, including internal, flat and external grips while conforming to the workpiece shape and workpiece cavities. The configuration is readily reconfigurable to different workpiece geometries.

An embodiment of a workpiece holder including one or a plurality of conformable magnetic holding devices provides a gripper element where the gripper may have one or more such elements to enable gripping a workpiece or supporting the workpiece while providing sufficient accessibility to enable welding. A workpiece holder including one or a plurality of conformable electro-magnetic holding devices provides a gripper element wherein the gripper may have one or more such elements to enable gripping of a workpiece while providing sufficient accessibility to enable welding or other work to be performed on or with the workpiece. One or more of the holding devices can be repositioned or reconfigured to a different location to accommodate different workpieces having differing geometries. A workpiece holder including one or a plurality of conformable magnetic or electro-magnetic holding devices provides a gripper element that is able to effect an external grip by folding around and conforming to a portion of a workpiece and through use of magnetic or electro-magnetic force. A workpiece holder including one or a plurality of conformable magnetic or electro-magnetic holding devices provides a gripper element that is able to effect an internal or flat grip to a portion of a workpiece through use of magnetic or electro-magnetic force. The workpiece holder including one or a plurality of conformable magnetic or electro-magnetic holding devices provides a gripper element that is able to effect a combination of one or more of external, internal and/or flat grips to a portion of a workpiece through use of magnetic or electro-magnetic force. The workpiece holder may be applied in any material handling situation, including but not limited to manufacturing and assembly processes, material handling and conveyancing, measurement, testing and the like.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

1. A device for holding a workpiece, comprising:
a holder including a base including a magnetic element;
a conformable jamming element attached to the base and including a closed impermeable pliable membrane containing dry magnetic particles; and
a controllable pressure device fluidly coupled to the jamming element.

2. The device of claim 1, wherein the closed impermeable pliable membrane further contains granular filling material.

3. The device of claim 1, wherein the dry magnetic particles comprise materials having a large, positive susceptibility to an external magnetic field.

4. The device of claim 3, wherein the materials having a large, positive susceptibility to an external magnetic field comprise iron, nickel, and cobalt.

5. The device of claim 1, further comprising the device employing magnetic force to effect a grip on the workpiece.

6. The device of claim 5, wherein the device employing magnetic force to effect a grip on the workpiece comprises the device employing the magnetic force to effect an internal grip on the workpiece.

7. The device of claim 5, wherein the device employing magnetic force to effect a grip on the workpiece comprises the device employing the magnetic force to effect an external grip on the workpiece.

8. The device of claim 1, wherein the conformable jamming element attached to the base and including a closed impermeable pliable membrane containing dry magnetic particles further comprises the base including a fluid conduit that fluidly couples to a pressure source, wherein the pressure source generates a negative pressure in the jamming element in response to a first control signal.

9. The device of claim 1, wherein the magnetic element comprises an electro-magnetic element, and further comprising a controllable voltage source electrically connected to the electro-magnetic element.

10. The device of claim 9, further comprising the electro-magnetic element generating a magnetic force in response to a second control signal communicated to the controllable voltage source coincident with the pressure source generating a negative pressure in the jamming element in response to a first control signal to effect gripping of a portion of the workpiece.

11. The device of claim 1, wherein the magnetic element comprises a permanent magnetic element.

12. The device of claim 11, wherein the device employs magnetic force to effect a grip on the workpiece.

13. The device of claim 12, wherein the device employing magnetic force to effect a grip on the workpiece comprises the device employing the magnetic force to effect an internal grip on the workpiece.

14. The device of claim 12, wherein the device employing magnetic force to effect a grip on the workpiece comprises the device employing the magnetic force to effect an external grip on the workpiece.

15. The device of claim 12, further comprising the pressure source generating a negative pressure in the jamming element in response to a first control signal to effect a grip on the workpiece.

16. A device for holding a workpiece, comprising:
a holder including a base including a controllable electro-magnetic element;
a conformable jamming element attached to the base and including a closed impermeable pliable membrane containing a magnetic fluid;
a controllable pressure device fluidly coupled to the jamming element; and
a controllable voltage source electrically connected to the electro-magnetic element.

17. The device of claim 16, wherein the magnetic fluid comprises a ferro-fluid.

18. The device of claim 16, wherein the magnetic fluid comprises a magnetorheological fluid.

19. A holder for gripping a workpiece, comprising:
a plurality of conformable holding devices, each holding device including a base including a controllable electro-magnetic element, a conformable jamming element attached to the base and including a closed impermeable pliable membrane containing magnetic particles, a controllable pressure device fluidly coupled to the jamming element, and a controllable voltage source electrically connected to the electro-magnetic element;
a controllable pressure device fluidly coupled to the conformable jamming elements,
a controllable voltage source electrically connected to the electro-magnetic elements; and
a controller communicating with the controllable pressure device and the controllable voltage source;
wherein the electro-magnetic elements grip portions of the workpiece in response to commands from the controller to the controllable pressure device and the controllable voltage source; and
wherein one of the conformable holding devices has freedom of motion on the holder that is adaptable to the workpiece.
